(19) United States
(12) Patent Application Publication
(10) Pub. No.: US 2005/0128895 A1
(43) Pub. Date: Jun. 16, 2005

(54) Optical head and optical disc apparatus equiped with optical head

(75) Inventors: Isao Hoshino, Yokohama-shi (JP); Kunio Omi, Yokohama-shi (JP); Yasuhisa Takamura, Fujisawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/042,062

(22) Filed: Jan. 26, 2005

Related U.S. Application Data
(62) Division of application No. 09/695,284, filed on Oct. 25, 2000.

(30) Foreign Application Priority Data
Oct. 26, 1999 (JP) 11-304021
Oct. 29, 1999 (JP) 11-309717

(51) Int. Cl. G11B 7/00

(52) U.S. Cl. 369/44.15

(57) ABSTRACT

Disclosed is an optical head comprising a light source for emitting a light beam having a predetermined wavelength, a light source driving part for driving the light source, a monitor light detector for detecting the light amount of the light beam emitted from the light source, an objective lens for collecting the light beam on a predetermined position of the optical disc, a light receiving element for receiving the light beam reflected from the optical disc so as to convert the received light beam into an electric signal, a base having an open portion and holding an optical member for guiding the light beam in the open portion in a manner to form an optical path of the light beam ranging from the light source to the objective lens, and holding means for holding the monitor light detector within the open portion in parallel to the optical path so as not to interfere with the light beam. The particular construction permits providing a miniaturized and thin optical head capable of overcoming the mounting layout of the members.

### CROSS-REFERENCE TO RELATED APPLICATIONS

This application is a divisional of U.S. application Ser. No. 09/695,284, filed Oct. 25, 2000, which claims the benefit of priority from Japanese Patent Application No. 11-304021, filed Oct. 26, 1999, and Japanese Patent Application No. 11-309717, filed Oct. 29, 1999, the entire contents of which are incorporated herein by reference.

### BACKGROUND OF THE INVENTION

The present invention relates to an optical head for recording data in a recording medium of an optical disc by using a laser beam or for reproducing the data recorded in an optical disc and an optical disc apparatus equipped with the particular optical head.

An optical head is constructed such that, when data are recorded, a recording surface of an optical disc is irradiated with a laser beam having a plurality of predetermined light intensities so as to change the structure of the recording surface of the optical disc, thereby forming recording marks having a plurality of different reflectances so as to record the data.

The recording method includes, for example, a phase change recording method in which the phase of the recording surface of an optical disc is changed so as to change the level of the reflected light in a plurality of graduations, and a chromatic change type recording method in which a photosensitive chromatic is arranged on the recording surface of the optical disc and the level of the reflected light is made binary by the color development of the chromatic.

The construction of the known optical head and the recording-reproducing principle thereof will now be described with reference to FIGS. 10A and 10B. FIG. 10A shows the state of a known optical head as viewed in a planar direction, i.e., in a direction perpendicular to the recording surface of the optical disc, and FIG. 10B shows the state of the known optical head as viewed in a direction parallel to the recording surface of the optical disc.

As shown in FIGS. 10A and 10B, an optical head 900 includes a base 901. Arranged within the base 901 is a laser diode 91 emitting a laser beam of a predetermined wavelength. The laser beam emitted from the laser diode 91 is reflected from the recording surface of an optical disc and the reflected light is received by a light detector 92. The laser diode 91 and the light detector 92 collectively form an IOU (Integrated Optical Unit) 90. Also arranged within the base 901 are a beam splitter 93 arranged on the optical path of the laser beam emitted from the laser diode 91 of the IOU 90, a collimator 95 for converting the laser beam passing through the beam splitter 93 into a parallel light, a mirror block 96 for reflecting the laser beam collimated by the collimator 95 in a direction of right angles, and an objective lens 97 for collecting the laser beam reflected from the mirror block 96 on a predetermined position of a recording surface of the optical disc. Also arranged is a lens 94 for collecting the laser beam reflected in a direction of right angles from the laser beam running toward the collimator 95 on a light receiving surface of the light detector 92. It follows that an optical path for irradiating an optical disc in a predetermined position with a laser beam is formed between the laser diode 91 (IOU) and the objective lens 97.

It should be noted that a laser driving circuit member 98 for driving the laser diode 91 of the IOU 90 and the light detector 92 are fixed to the outer wall of the base 901.

Data are recorded by the optical head 900 as follows.

Specifically, the laser diode 91 is operated on the basis of the driving signal generated from the laser driving circuit member 98. The laser beam emitted from the laser diode 91 is incident on the beam splitter 93. A predetermined proportion of the laser beam incident on the beam splitter 93 passes through the beam splitter 93 so as to be guided to the mirror block 96. The beam guided to the mirror block 96 is reflected toward the objective lens 97 so as to be collected on a predetermined position on the recording surface of an optical disc D. On the other hand, that portion of the laser beam which is incident on the beam splitter 93 and is not reflected toward the mirror block 96 is reflected toward the monitor light detector 92.

The monitor light detector 92 is arranged to receive a part of the laser beam emitted from the laser diode in order to detect the light intensity of the laser beam irradiating the optical disc. The system of detecting the light intensity of the laser beam running forward toward the optical disc, not for detecting the monitor laser light inherent in the laser diode emitted rearward of the laser diode (light source), is called a front monitor system, which is a construction inherent in the recording optical head 900 in which it is necessary to supervise strictly the intensity of the laser beam in recording a digital signal in an optical disc. To be more specific, since the rise and fall of a recording laser beam for recording a digital signal are required to form an ideal rectangular wave, the light amount of the laser beam emitted from the laser diode is detected and fed back so as to have the output of the laser diode kept controlled.

The optical head 900 shown in FIGS. 10A and 10B is used in a relatively large optical disc apparatus and, thus, the optical head 900 itself is large. Therefore, the laser driving circuit member 98 and the monitor light detector 92 can be mounted to the outer wall of the base 901.

However, in accordance with requirement for miniaturization of the optical disc apparatus, the optical head 900 is also miniaturized. As a result, the size of the part that can be mounted to the housing member corresponding to the base 901 is limited.

Particularly, when it comes to the optical disc apparatus used in a notebook type personal computer, the thickness of the optical disc apparatus is required to be further decreased, making it necessary to limit the height of the optical head 900 to a very small range. As a result, the mounting layout in mounting the peripheral parts of the optical head is greatly restricted.

Also, since the optical disc of a DVD type has been put to a practical use, it is desired that the recording of data on optical discs such as a CD-R and a CD-DW capable of reproducing a CD disc for music or capable of recording data with a CD type optical disc be performed in a single optical disc in an optical disc apparatus capable of reproducing a DVD type optical disc. Under the circumstances, the optical head is required to be further miniaturized and to be made thinner.

### BRIEF SUMMARY OF THE INVENTION

An object of the present invention is to provide a miniaturized optical head capable of overcoming the restriction in the mounting layout of parts and suitable for mounting in a thin optical disc apparatus.

Another object of the present invention is to provide an optical head, which can be housed in a thin optical disc apparatus, the optical head being capable of reproducing a DVD disc and a CD disc, and capable of recording data in optical discs in which data can be recorded such as a CD-R disc and a CD-RW disc.

According to a first aspect of the present invention, there is provided an optical head device comprising:
a light source for emitting a light beam having a predetermined wavelength;
a laser driving circuit member for driving the light source for allowing the light source to emit the light beam;
a monitor light detecting part for detecting the light amount of the light beam emitted from the light source;
an objective lens for collecting the light beam on a predetermined position of the optical disc;
a light receiving element for receiving the light beam reflected from the optical disc and for converting the received light beam into an electric signal;
a base having an open portion and holding an optical member arranged in the open portion for guiding the light beam in a manner to form an optical path of the light beam from the light source to the objective lens;
a holding member for holding the monitor light detecting part within the open portion of the base in parallel to the optical path and in a manner not to interfere with the light beam;
a guide member for guiding the optical head in the radial direction of the optical disc; and
a disk motor for rotating the optical disk by predetermined speed.

According to a second aspect of the present invention, there is provided an optical head used in an optical disc apparatus in which an optical disc is irradiated with a light beam for recording data in the optical disc or for reproducing data from the optical disc, at least one of a circuit member and an element for reproducing or recording data being housed in the optical head, comprising:
a light source for emitting a light beam having a predetermined wavelength;
an objective lens for collecting the light beam for irradiating the optical disc with the light beam;
a driving mechanism for moving the objective lens in a predetermined direction for at least one of a focusing and a tracking to the optical disc;
a light receiving element for receiving the light beam reflected from the optical disc and for converting the receiving light beam into an electric signal;
a base having an open portion and holding an optical member arranged in the open portion for guiding the light beam in a manner to form an optical path of the light beam from the light source to the objective lens;
a light source driving circuit member which comprises the light source driving circuit for driving the light source;
a signal processing circuit member which comprises the signal processing circuit for processing the electric signal from the light receiving element;
a driving mechanism driving circuit for driving the driving mechanism; and
a holding member for holding at least one of the driving circuit member, the light source driving circuit member, the signal processing circuit member, and the driving mechanism driving circuit member within the open portion of the base in parallel manner to the optical path within the base and in a manner not to interfere with the optical path within the base.

Further, according to a third aspect of the present invention, there is provided an optical head, comprising:
an objective lens for irradiating an optical disc with a light beam and for receiving the light beam reflected from the optical disc;
a first light source for emitting a first light beam having a first wavelength;
a second light source for emitting a second light beam having a second wavelength;
an optical path synthesizing-separating element for allowing the first beam and the second beam to be incident on the objective lens and for separating beams reflected from the objective lens, the reflected beams corresponding to the first and second light beams, respectively;
first and second light detectors for detecting the first and second reflected beams, respectively, reflected from the optical path synthesizing-separating element; and
a converging optical system arranged between the second light source and the optical path synthesizing-separating element for diminishing the diverging angle of the diverging light flux emitted from the second light source so as to guide the light flux to the optical path synthesizing-separating element.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1A is a plan view showing an optical head according to one embodiment of the present invention, as viewed in a direction parallel to a recording surface of an optical disc;

FIG. 1B is a side view showing the optical head shown in FIG. 1A, as viewed in a direction perpendicular to the recording surface of the optical disc;

FIG. 2 schematically shows the outer appearance of a base forming the optical head body shown in FIGS. 1A and 1B;

FIG. 3 schematically shows the inner state of the base shown in FIG. 2 as viewed from the rear side;

FIG. 4 shows in a dismantled fashion the base and the optical head arranged within the base, which are shown in FIGS. 2 and 3;

FIG. 5 schematically shows an embodiment of the present invention where a laser driving circuit member is set on the base as viewed from the rear side, which is shown in FIG. 3;

FIG. 6 is a side view of the base shown in FIGS. 2 to 5;

FIG. 7 is a plan view schematically showing an embodiment of the present invention where base shown in FIGS. 2 to 6 is incorporated in a motor base of an optical disc apparatus;

FIG. 8 schematically explains an embodiment of the present invention where the motor base shown in FIG. 7 is assembled with the optical disc apparatus;

FIG. 9A is a plan view showing an embodiment of the present invention where an optical head differing from the optical head shown in FIGS. 1A and 13 is observed in a direction parallel to the recording surface of the optical disc;

FIG. 9B is a side view showing an embodiment of the present invention where the optical head shown in FIG. 9A is observed in a direction perpendicular to the recording surface of the optical disc;

FIG. 10A is a plan view showing an embodiment of the present invention where the optical head applied to a known large optical disc apparatus is observed in a direction parallel to the recording surface of the optical disc;

FIG. 10B is a side view showing an embodiment of the present invention where the optical head shown in FIG. 10A is observed in a direction perpendicular to the recording surface of the optical disc;

FIG. 11 schematically explains the developed state of the main constituents which are extracted from the optical head shown in FIGS. 1A, 1B, 2 to 6, 9A and 9B;

FIG. 12 schematically illustrates the configuration of the main constituents of another optical head, which can be applied to the optical head shown in FIGS. 1A, 1B, 2 to 6, 9A and 9B;

FIG. 13A is a graph showing the relationships between the optical magnification and the light utilization and between the optical magnification and the power of the laser beam emitted from the objective lens in the case of using the optical head shown in FIG. 11 or 12;

FIG. 13B is a graph showing the Gaussian distribution of the laser beam irradiating the optical disc in the case of using the optical head shown in FIG. 11 or 12;

FIG. 14 is a graph showing the direction relative to the light source of the lens differing from the objective lens included in the optical head shown in FIG. 11 or 12 and explaining the degree of influence of the wave front aberration in the case where a lens shift is imparted to the objective lens;

FIGS. 15A to 15D schematically explain the inclination of the lens differing from the objective lens included in the optical head shown in FIG. 11 or 12 and the state of the ghost light caused by 0 order light of the laser beam or ±1 order light of the laser beam;

FIG. 15E is a graph for explaining the magnitude of each of the ghost light beams caused by the conditions shown in FIGS. 15A to 15D;

FIGS. 16A to 16C schematically explain the information recording surfaces of various optical discs in which data can be recorded and from which data can be reproduced by the optical head shown in FIGS. 1A, 1B, 9A and 9B; and

FIG. 17 is a block diagram schematically showing the signal processing system for obtaining a reproducing signal, a tracking signal and a focus signal from the reflected laser beam reflected from the optical disc obtained by using the optical head shown in FIGS. 1A, 1B, 9A, 9B, 11 or 12.

### DETAILED DESCRIPTION OF THE INVENTION

The construction of an optical head according to one embodiment of the present invention will now be described with reference to the accompanying drawings.

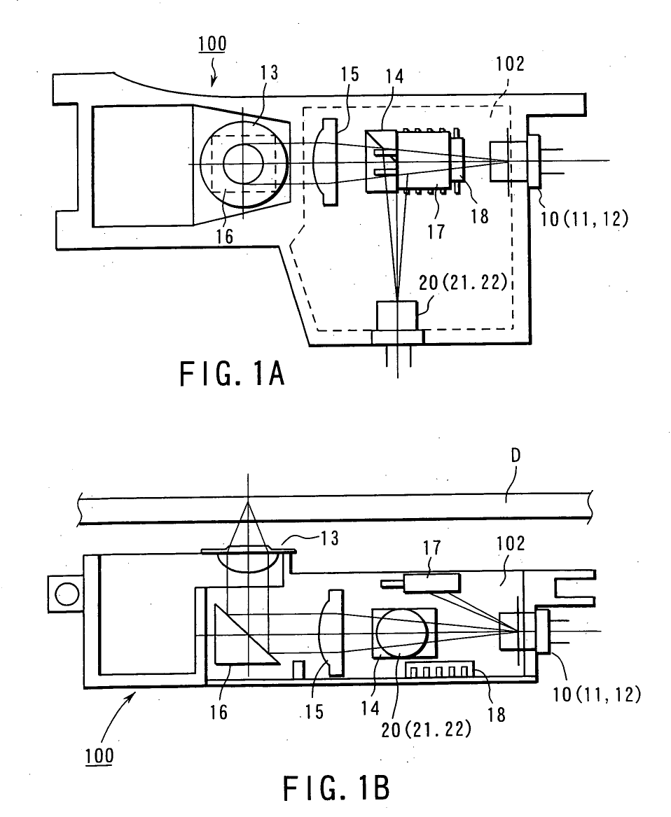

FIGS. 1A and 1B collectively show an optical head according to one embodiment of the present invention. Specifically, FIG. 1A is a plan view of the optical head as viewed in a direction parallel to the recording surface of the optical disc, and FIG. 1B is a side view showing the state as viewed in a direction perpendicular to the recording surface of the optical disc.

As shown in FIGS. 1A and 1B, an optical head 100 includes a base 101, an IOU (Integrated Optical Unit) 10 arranged in a predetermined position within the base 101, a laser diode 11 arranged within the IOU 10 to act as a first light source and emitting a laser beam (light beam) of a first wavelength, and a light detector 12. The laser beam emitted from the laser diode 11 is reflected from a recording medium of an optical disc D, and the reflected laser beam is received by the light detector 12. Upon receipt of the reflected laser beam, the light detector 12 produces an electric signal conforming with the intensity of the reflected laser beam. The base 101 includes an open portion 102 in which is formed an optical path for transmitting the laser beam of the first wavelength emitted from the laser diode 11 of the IOU 10 to the objective lens 13 for collecting the laser beam on a recording surface of the optical disc D.

Arranged within the open portion 102 along the optical path extending from the laser diode 11 within the IOU 10 to the objective lens 13 are a beam splitter 14, a collimator 15 for converting the laser beam passing through the beam splitter 14 into a parallel light, and a mirror block 16 for reflecting the laser beam collimated by the collimator 15 in substantially right angles toward the objective lens 13. The laser beam of the first wavelength emitted from the laser diode 11 has a wavelength of, for example, 780 nm and can be used for reproducing data from a known CD type optical disc and for recording data in a CD-R disc or a CD-RW disc.

On the other hand, a second IOU 20 for DVD is arranged in a predetermined position within the open portion 102 of the base 101 in a direction substantially perpendicular to the line joining the laser diode 11 of the IOU 10, the light detector 12 and the beam splitter 14. The second IOU 20 has a laser diode 21 emitting a laser beam having a second wavelength, which can be applied to an optical disc of a DVD type, and a light detector 22 formed integrally with the laser diode 21. The laser beam of the second wavelength emitted from the laser diode 21 is reflected from the optical disc and the reflected second laser beam is received by the light detector 22.

The laser beam emitted from the second laser diode within the IOU 20 for DVD has a wavelength of, for example, 650 nm. The laser beam is reflected by the beam splitter 14 toward the collimator 15 while gradually diverging along the optical path within the open portion 102 and, then, collimated by the collimator 15 so as to be guided to the mirror block 16. It follows that both the laser beam having a wavelength of 780 nm, which is emitted from the laser diode 11 of the IOU 10 for CD described previously, and the laser beam having a wavelength of 650 nm, which is emitted from the laser diode 21 of the IOU 20 for DVD, are incident on the objective lens 13.

As described above, the optical path within the open portion 102 is formed by the beam splitter 14, the collimator 15 and the mirror block 16.

A monitor light detector 17, which receives a part of the laser beam emitted from the laser diode 11 of the IOU 10 for CD for detecting the light amount of the laser beam irradiating the optical disc, is arranged within the open portion 102 of the base 101.

As apparent from FIG. 1B, the monitor light detector 17 is fixed to a ceiling portion positioned closer to the optical disc than the beam splitter 14 within the open portion 102 (optical path). On the other hand, a laser driving circuit member 18 for driving the laser diode 11 within the IOU 10 for CD is held in a floor portion positioned farther from the optical disc than the beam splitter 14 within the open portion (optical path) 102, as apparent from FIG. 1B.

The principle of data reproduction from a DVD type disc and a CD type disc by the optical head 100 shown in FIGS. 1A and 1B will now be described.

The optical head shown in FIGS. 1A and 1B is an interchangeable head capable of reproducing data from optical discs (DVD, CD) differing from each other in standards.

The format of the CD type is capable of application to a CD-R and a CD-RW capable of recording. Where CD-R or CD-RW is mounted, the laser beam for CD permits recording data by changing the structure of the recording surface to cause the reflected light to have two different intensities.

The principle of reproducing a DVD disc will now be described first.

The laser beam emitted from the laser diode 212 included in the IOU 20 for DVD is reflected by the beam splitter 14 having a dichroic film capable of reflecting the laser beam having the second wavelength (650 nm) formed thereon so as to be guided to the collimator 15. The laser beam guided to the mirror block 16 is reflected by the mirror surface of the mirror block 16 toward the objective lens 13 so as to be imparted with predetermined converging properties by the objective lens 13 and, then, collected on a predetermined position (pit column) on the recording surface of the optical disc D, which is a DVD type disc.

If the optical disc D conforms with DVD standards, the laser beam collected on the recording surface is reflected by the recording surface of the optical disc D so as to be brought back to the objective lens 13. The laser beam is then converted into a parallel light by the objective lens 13 and, then, further reflected by the mirror block 16 so as to be brought back to the beam splitter 14. The reflected laser beam that is brought back to the beam splitter 14 is reflected toward the IOU 20 for DVD by the function of the dichroic film of the beam splitter 14.

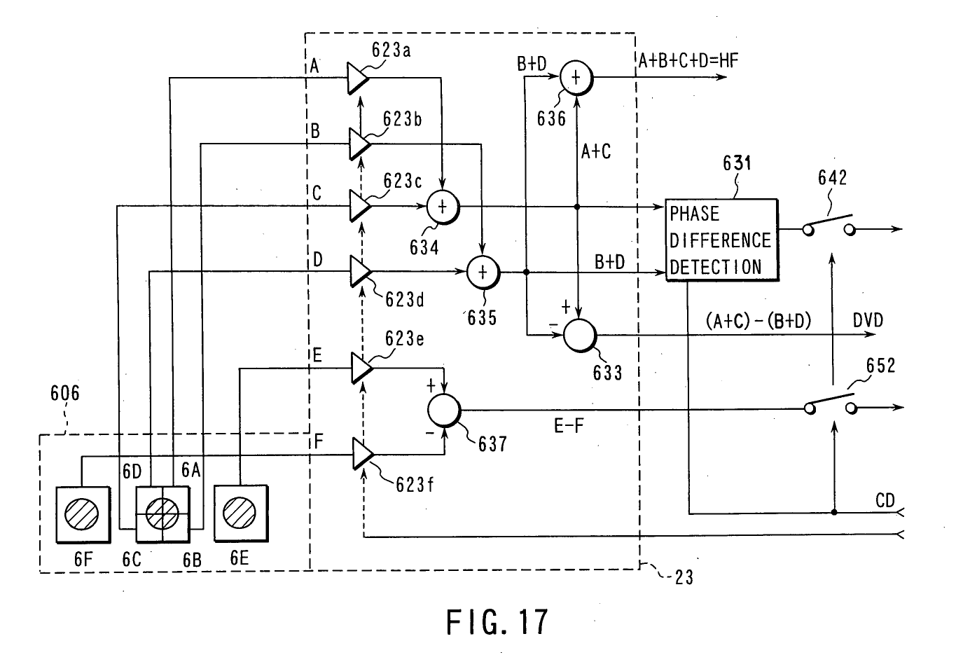

The reflected laser beam guided to the IOU 20 for DVD is received by the light detector 22 of the IOU 20 for DVD so as to be converted into an electric signal. Then, the electric is processed in a signal processing circuit shown in, for example, FIG. 17, so as to be converted into an RF signal (reproduction signal), a focus error signal and a tracking error signal. These converted signals are output. Incidentally, the RF signal is output from the optical head so as to be reproduced as a data signal by a digital signal processing circuit (not shown) within the optical disc apparatus. On the other hand, the focus error signal and the tracking error signal are utilized for the known focus control for aligning the distance between the position of the objective lens 13 and the recording surface of the optical disc D with the focus point of the objective lens 13 and for the known tracking control for aligning the center of the laser beam passing through a predetermined position of the objective lens 13 so as to be collected on the recording surface of the optical disc D with the center of the pit column formed on the recording surface.

The principle of reproducing the data signal from a CD type disc or recording the data signal in a CD-R disc or a CD-RW disc will now be described.

Specifically, the laser beam emitted from the laser diode 11 included in the IOU 10 for CD is transmitted through the beam splitter 14 provided with a dichroic film capable of transmitting the laser beam having the first wavelength (780 nm) and, then, converted into a substantially parallel light by the collimator 15 so as to be guided to the mirror surface of the mirror block 16.

The laser beam guided to the mirror block 16 is reflected toward the objective lens 13 so as to be imparted with predetermined converging properties by the objective lens 13 and, thus, to irradiate the recording surface of the optical disc D. Therefore, if the optical disc D conforms with the CD standards, the irradiating laser beam is reflected by the recording surface of the optical disc D so as to be brought back to the objective lens 13. Then, the light is converted into a substantially parallel reflected laser beam so as to be brought back to the mirror block 16.

The reflected laser beam guided to the mirror block 16 passes through the beam splitter 14 so as to be incident on the light detector 12 included in the IOU 10 for CD.

The reflected laser beam guided to the light detector 12 included in the IOU 10 for CD is converted into an electric signal by the light detector 12 and, then, processed by the signal processing circuit shown in, for example, FIG. 17, so as to generate predetermined electric signals capable of forming an RF signal (reproduction signal), a focus error signal and a tracking error signal.

The above description covers the case where the optical disc D is a known CD type optical disc. The case of recording data in an optical disc conforming with the CD-R or CD-RW standards is equal to the above case in that the laser beam having the first wavelength (780 nm), which is emitted from the laser diode 11 included in the IOU 10 for CD, is transmitted through the beam splitter 14, the collimator 15 and the mirror block 16 so as to irradiate the optical disc D. Where the optical disc D is a CD-R disc, the intensity of a laser beam of a recording power having the maximum light intensity higher than that of the laser beam irradiating the optical disc D of CD type is modulated by the driving circuit member 18 in accordance with the data to be recorded and, then, the chromatic film on the recording surface of the optical disc D is irradiated with the laser beam having the maximum light intensity modulated by the driving circuit member 18. As a result, changes are generated in the chromatic film so as to record the data. Similarly, in the case of the CD-RW disc, phase changes are generated in that portion of the recording film which is irradiated with the laser beam of the recording power so as to record the data.

As described above, the optical head 100 shown in FIGS. 1A and 1B is capable of coping with discs of different formats, and, thus, is configured so that a plurality of optical systems such as IOU are housed in a single base 101. Therefore, when the head is miniaturized, the layout of the parts housed within the optical head 100 is restricted.

In the optical head 100, the open portion 102 in which the optical path is arranged is increased with an increase in the optical path. The open portion is a relatively large space within the optical head 100, and components other than the optical components forming the optical path are not disposed in the open portion.

Under the circumstances, in the optical head 100 shown in FIGS. 1A and 1B, attention is paid to the space in which is arranged the optical path of the laser beam ranging between the laser diode 11 and the objective lens 13, and members for controlling the data recording in and data reproduction from the optical disc D are arranged appropriately in the open portion 102, in which the optical path is arranged, of the optical head 100.

To be more specific, the main members arranged within the open portion 102 are the laser driving circuit member 18 for driving the laser diode 11 and the monitor light detector 17.

The laser driving circuit member 18 and the monitor light detector 17 are arranged within the open portion 102 substantially in parallel to the optical path of the laser beam so as not to intercept the optical path of the laser beam. Incidentally, in the optical head shown in FIGS. 1A and 1B, the laser driving circuit member 18 is arranged farther from the optical disc D than the beam splitter 14, which is arranged in substantially the center of the open portion 102. On the other hand, the monitor light detector 17 is arranged closer to the optical disc D than the beam splitter 14, which is arranged in substantially the center of the open portion 102.

As described above, in the optical head shown in FIGS. 1A and 1B, the free space in which the optical path is formed is effectively utilized so as to overcome the restriction in the layout of the members arranged within the optical head 100. As a result, the optical head 100 can be miniaturized while decreasing the thickness thereof. Incidentally, in the optical head 100 described above, the monitor light detector 17 and the laser driving circuit member 18 are arranged within the open portion 102. It should be noted in this connection that the technical idea of the present invention is to arrange the members for controlling the data reproduction and recording within the open portion 102 so as not to intercept the laser beam. It follows that it is possible to arrange within the open portion 102 other members such as an actuator driver for changing the position of the objective lens 13 and a signal processing circuit.

Also, in the optical head 100 shown in FIGS. 1A and 1B, the laser beam emitted from the laser diode 11 of the IOU 10 for CD is gradually diverged along the optical path. In other words, the laser beam has a small diameter on the emitting side near the light source. Therefore, relatively large members can be arranged if the monitor light detector 17, the laser driving circuit member 18, the actuator driver or the signal processing circuit are arranged in the space on the emitting side of the open portion 102 near the light source.

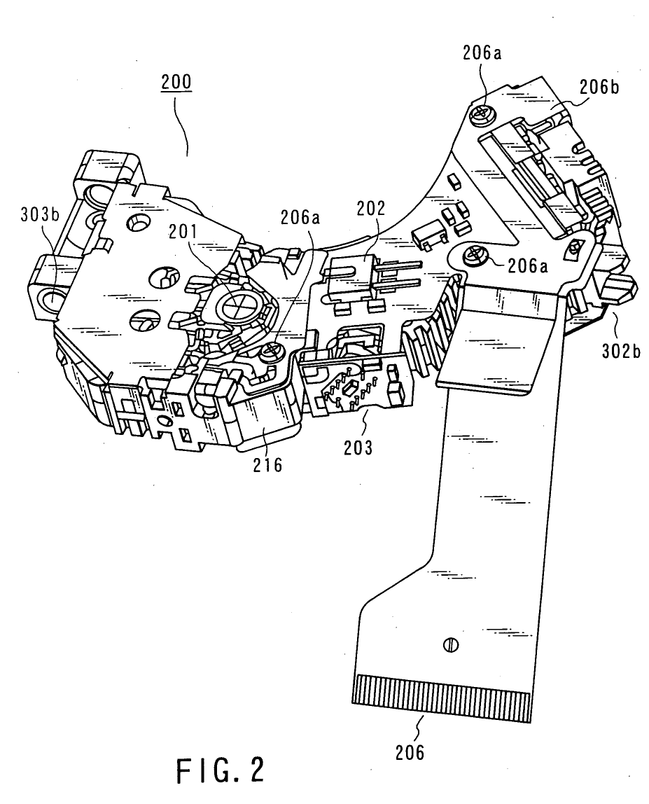

FIGS. 2 to 6 schematically show another embodiment of the optical head shown in FIGS. 1A and 1B.

As shown in FIG. 2, in an optical head 200, an objective lens 201 for collecting the laser beam emitted from the laser diode on a predetermined position on the recording surface of the optical disc D, a member held a monitor light detector 202 and an IOU 203 for CD are mounted to a base 216, which is a main body portion of the optical head.

A plate-like (claw-like) guide bearing 302b arranged on one edge portion of the base 216 and a cylindrical guide bearing 303b arranged on the other edge of the base 216 are coupled with guide shafts (not shown) so as to hold the optical head 200 such that the optical head 200 is movable to an optional position in a radial direction of the optical disc D. The monitor light detector 202 is fixed to the base 216 by a screw 206a with a flexible printed circuit board 206 interposed there between. A holding plate 206b is mounted on the flexible printed circuit board 206 in order to suppress the rocking of the optical head 200 when the optical head 200 is moved along a guide shaft (not shown). The holding plate 206b is fixed together with the printed circuit board 206 to the base 216 by the screw 206a.

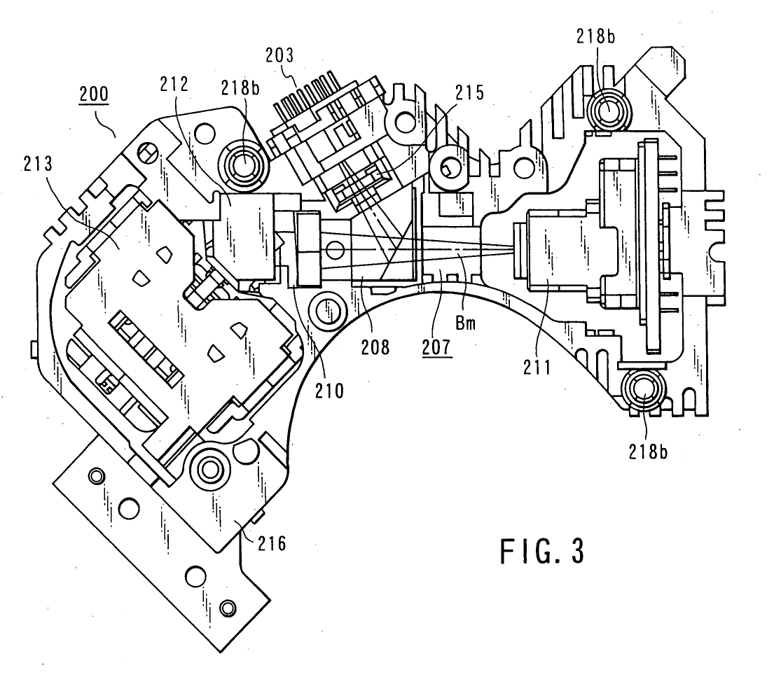

FIG. 3 shows the inner structure of the optical head covering the state that the inner region of the base shown in FIG. 2 is viewed from the rear side. As apparent from FIG. 3, an IOU 211 for DVD, an IOU 203 for CD, a coupling lens 215, a beam splitter 208, a collimator 210, a mirror block 212, and a yoke 213 constituting an actuator are arranged within an open portion 207 of the base 216. Incidentally, screw holes 218b for receiving screws (not shown), which is for fixing a metal cover (not shown), are formed on the side of the IOU 211 for DVD of the base 216.

Upon receipt of a driving signal given by an actuator driver (not shown), the actuator 213 drives the objective lens 201 in each of the focus direction and the track direction of the optical disc D.

A laser diode (not shown) included in the IOU 211 for DVD emits a laser beam Bm having a wavelength of 650 nm toward the optical disc D of DVD standards.

The emitted laser beam Bm, which is a diverging beam, is transmitted through the beam splitter 208, collimated by the collimator 210 and, then, is incident on the mirror block 212. The laser beam Bm guided to the mirror block 212 is reflected by the mirror block 212 toward an objective lens 201 shown in FIG. 2. Then, the laser beam BM is collected by the objective lens 201 on a predetermined position on the recording surface of the optical disc D.

The laser beam irradiating the optical disc D is reflected from the recording surface of the optical disc D so as to be incident again on the objective lens 201. The reflected laser beam incident on the objective lens 201 passes through the mirror block 212, the collimator 210 and the beam splitter 208 so as to be brought back to the IOU 211 for DVD.

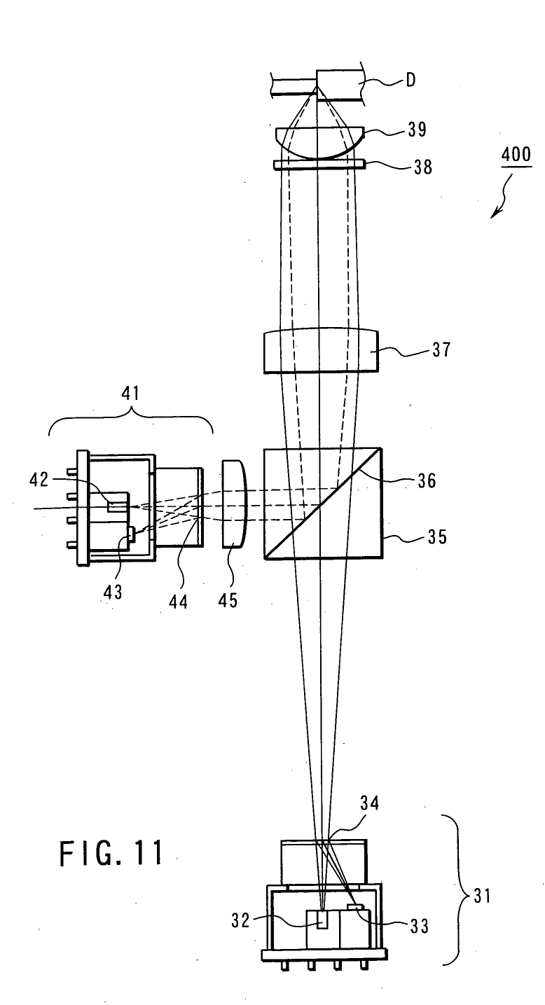

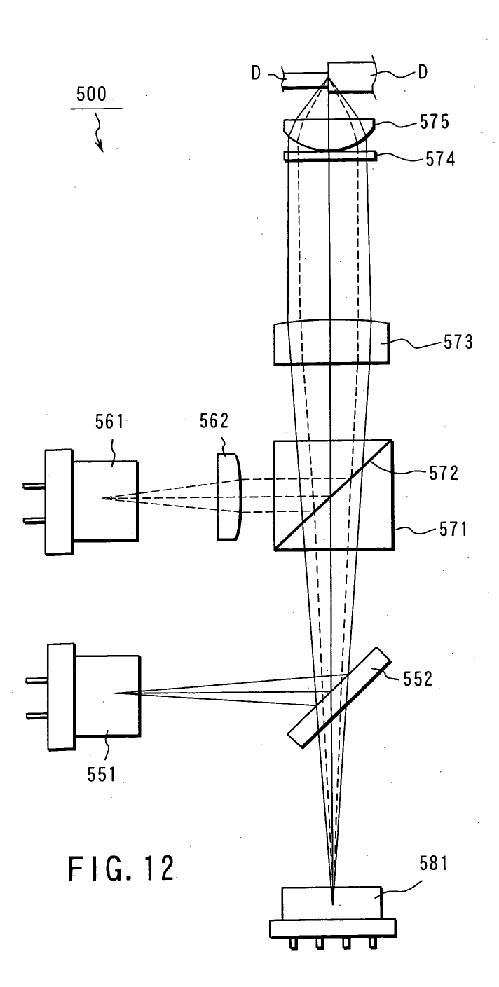

A hologram element explained herein later with reference to FIG. 11 or 12 is arranged within the IOU 211 for DVD. The reflected laser beam is guided to a light detector shown in FIG. 11 or 12 by the diffraction effect produced by a pattern (not shown) formed in the hologram element. The reflected laser beam is converted into electric signals by the light detector, with the result that an RF signal, a focus error signal and a tracking error signal are generated from the light detector.

The laser diode included in the IOU 203 for CD emits a laser beam Bm having a wavelength of 780 nm to a disc of the CD standard. The disc of the CD standard includes the optical discs conforming with the CD-R or CD-RW standards.

The laser beam Bm emitted from the laser diode, which is a diverging beam, is imparted with a predetermined cross sectional beam diameter in the coupling lens 215 and, then, reflected by the beam splitter 208. Further, the reflected laser beam is collimated by the collimator 210 and, then, guided to the mirror block 212. The laser beam Bm is reflected by the mirror block 212 so as to be incident on the objective lens 201 shown in FIG. 2. The objective lens 201 permits a predetermined position on the recording surface of the optical disc D to be irradiated with the laser beam.

The laser beam irradiating the optical disc D is reflected from the recording surface of the optical disc D so as to be brought back to the objective lens 201 and, then, is guided to the IOU 203 for CD through the mirror block 212, the collimator 210, the beam splitter 208 and the coupling lens 215.

A hologram element explained herein later with reference to FIG. 11 or 12 is arranged within the IOU 203 for CD. The reflected laser beam is guided to a light detector shown in FIG. 11 or 12 by the diffraction effect produced by a pattern (not shown) formed in the hologram element. The reflected laser beam is converted into electric signals by the light detector, with the result that an RF signal, a focus error signal and a tracking error signal are generated from the light detector.

The above description on the optical disc of the CD standard covers a CD disc exclusively for reproduction. The case where the set optical disc is a CD-R or CD-RW disc is equal to the above case in that the laser beam having the first wavelength of 780 nm, which is emitted from the laser diode 11 included in the IOU 10 for CD, passes through the beam splitter 14, the collimator 15, the mirror block 16 and the objective lens 13 so as to irradiate the optical disc D. Where the optical disc D is formed of a CD-R disc, the intensity of the laser beam of the recording power, which has the maximum light intensity higher than that of the laser beam irradiating the optical disc D of CD type, is modulated by the driving circuit member 18 in accordance with the data to be recorded. In this case, the chromatic film on the recording surface of the optical disc D is irradiated with the intensity-modulated laser beam so as to bring about changes in the chromatic film and, thus, to perform the data recording. Similarly, in the case of the CD-RW disc, phase changes are brought about in that portion of the recording film which is irradiated with the laser beam of the recording power so as to perform the data recording.

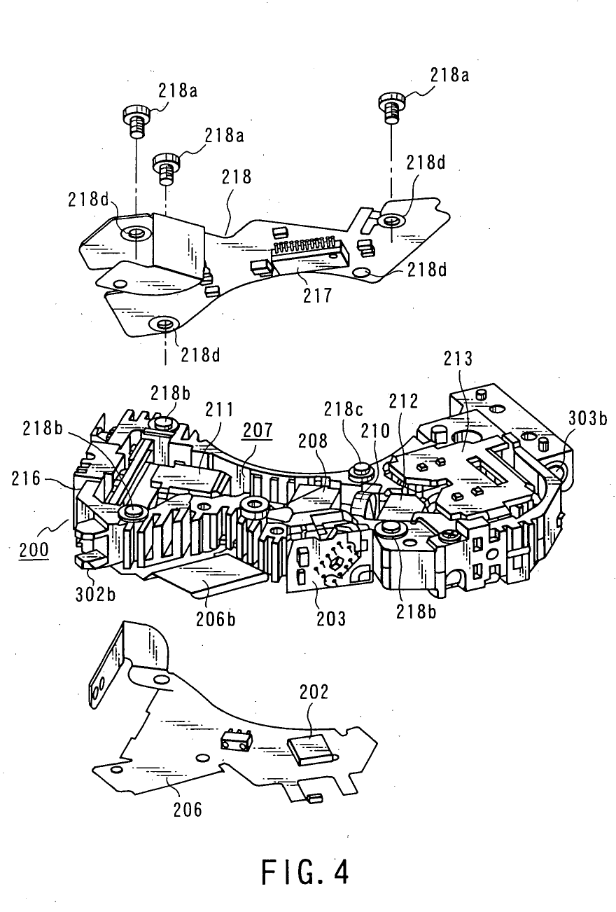

FIG. 4 is an oblique view showing in a dismantled fashion the optical head shown in FIGS. 2 and 3, the optical head being dismantled into the base, the top cover on the side of the optical disc and the bottom cover on the side remote from the optical disc.

The flexible printed circuit board 206 and the metal cover 218 are mounted to the base 216 of the optical head 200. As described previously, the monitor light detector 202 is mounted to the flexible printed circuit board 206.

A laser driving circuit 217 for driving the laser diode included in the IOU 203 for CD is mounted to the metal cover 218 with the flexible printed circuit board 218 interposed there between. Four openings 218d are formed in the metal cover 218. One of these four openings 218d is coupled with a projecting fulcrum 218c formed on the base 216 so as to determine the relative position between the cover 218 and the base 216. The metal cover 218 is fixed to the base 216 by inserting screws 218a through the remaining three openings 218d so as to be engaged with support portions 218b having internally threaded holes.

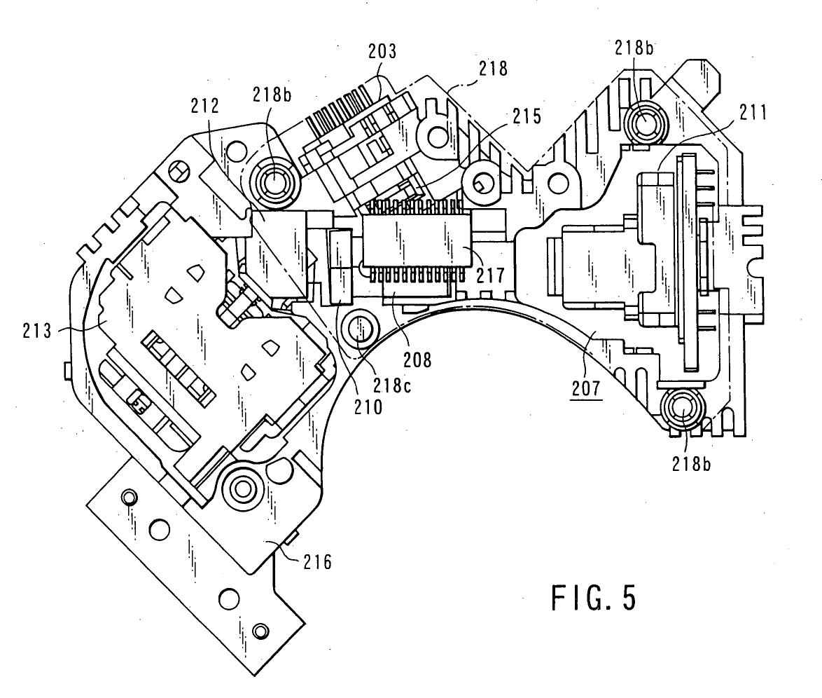

FIG. 5 shows the base shown in FIG. 4 as viewed from the side of the top cover 206. Incidentally, the laser driving circuit 217 cannot be seen originally because the metal cover 218 is fixed to the base 216 by the projecting fulcrum 218c and the three support portions 218b. However, in order to show the positional relationship between the optical path of the optical system arranged within the open portion 207 and the laser driving circuit 217, the laser driving circuit 217 is depicted to be seen through the metal cover 218 in FIG. 5.

As shown in FIG. 5, the laser driving circuit 217 arranged along the optical path and held in parallel to the optical path.

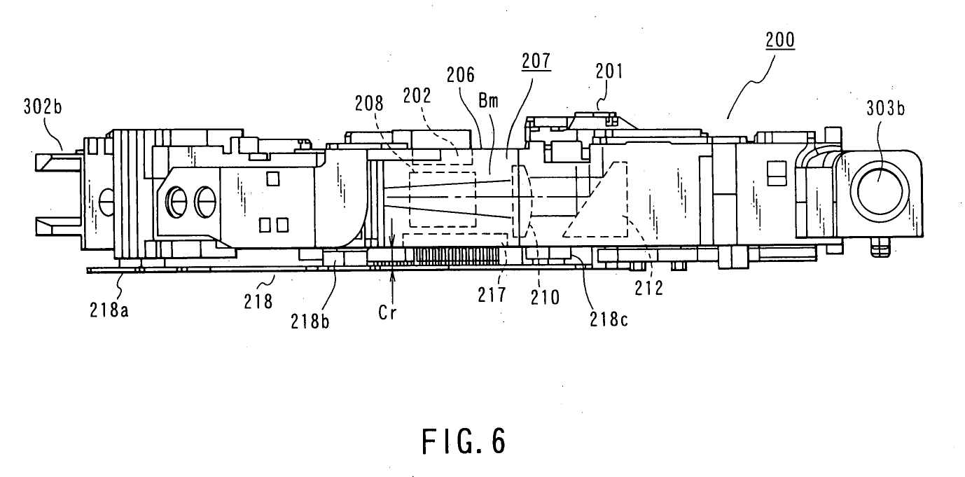

FIG. 6, which is a side view showing the base shown in FIGS. 2 to 5, shows the positional relationship among the laser driving circuit 217, the monitor light detector 202 and the optical path of the laser beam Bm. As shown in FIG. 6, the laser beam Bm emitted from the laser diode included in the IOU 211 for DVD passes through the beam splitter 208, is collimated by the collimator 210 and, then, guided to the mirror block 212. Therefore, the laser driving circuit 217 and the monitor light detector 202 are arranged within the open portion 207 of the optical head 200 in upper and lower portions of the base 216 in a manner to have the beam splitter 208 sandwiched there between.

The laser driving circuit 217 is mounted to the metal cover 218 with a flexible printed circuit board interposed there between and is inserted into the open portion 207 so as to be held on the base 216. In this case, the metal cover 218 having the laser driving circuit 217 mounted thereon is held by the support portions 218b and the projecting fulcrum 218c apart from the base 216 by the height of the clearance Cr.

As apparent from FIG. 6, the laser driving circuit 217 is exposed to the outer air through the clearance Cr, making it possible to obtain a cooling effect for cooling the laser driving circuit 217.

On the other hand, the monitor light detector 202 is mounted to the flexible printed circuit board 206 and is fixed to the base 216. Incidentally, as shown in FIG. 6, the laser driving circuit 217 and the monitor light detector 202 are arranged in parallel to the laser beam Bm and held so as not to interfere with the optical path of the laser beam Bm. In the optical head 200 shown in FIGS. 2 to 6, the laser driving circuit 217 and the monitor light detector 202 are arranged in parallel along the optical path ranging between the IOU 211 for DVD and the collimator 210. However, the laser driving circuit 217 and the monitor light detector 202 may be arranged anywhere desired as far as the laser driving circuit 217 and the monitor light detector 202 extend in parallel to the optical path of the laser beam ranging between the laser diode and the objective lens.

As described above, in the optical head shown in FIGS. 2 to 6, the space for forming an optical path is effectively utilized so as to overcome the restriction of the layout relating to many members housed in the optical head 200 so as to provide an optical head that is miniaturized and has a decreased thickness.

Needless to say, it is possible to arrange, for example, an actuator driver for moving the objective lens 201 in an optional direction and a signal processing circuit in the space for forming the optical path within the base 216 in the optical head shown in FIGS. 2 to 6 as in the optical head described previously in conjunction with FIGS. 1A and 1B.

As described above, in the optical head shown in FIGS. 2 to 6, the monitor light detector 202 is arranged above the beam splitter 208 and the laser driving circuit 217 is arranged below the beam splitter 208. It follows that the monitor light detector 202 and the laser driving circuit 217 do not interfere with the laser beam Bm in the upper and lower portions of the beam splitter 208.

FIG. 7 schematically shows an optical head unit 300 (motor substrate for an optical disc apparatus) having the optical head 200 shown in FIGS. 2 to 6 attached thereto.

As shown in FIG. 7, guide shafts 302a and 303a movably supporting the optical head 200 in a radial direction of the optical disc D are mounted in predetermined positions of the optical head unit 300. The guide shafts 302a and 303a are coupled with a claw-shaped guide bearing 302b and a cylindrical bearing 303b arranged on both edges of the base 206 of the optical head 200 so as to support the optical head 200 such that the optical head 200 can be moved to an optional position in the radial direction of the optical disc D.

The optical head unit 300 includes a turntable 301 for holding the optical disc D, a motor 303 producing a driving force for moving the optical head 200 in the radial direction of the optical disc D, and a pinion gear 304a for transmitting the driving force of the motor 303 to the optical head 200.

A rack 304b in mesh with the pinion 304a is arranged on the optical head 200. If the pinion 304a is rotated in a predetermined direction by the rotation of the motor 303, the rack 304b is moved in an optional direction so as to move the optical head 200 in an optional direction in the radial direction of the optical disc D.

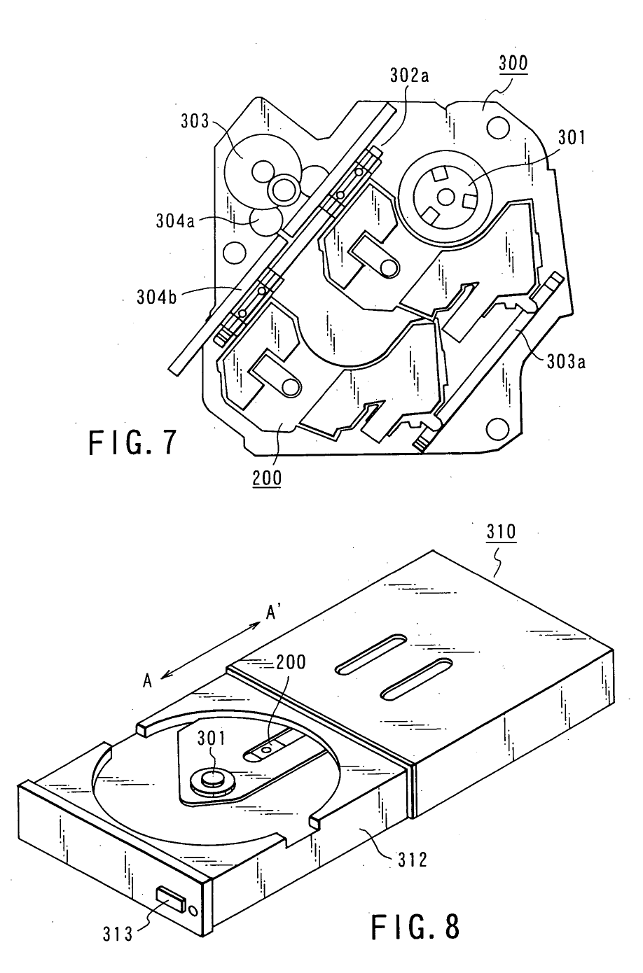

FIG. 8 schematically shows an optical disc apparatus equipped with a base 312 having the optical head unit 300 shown in FIG. 7 incorporated therein.

As shown in FIG. 8, the base 312 can be withdrawn in an A-A′ direction. The optical disc D is disposed on the turntable 301. Also, when data is reproduced from and recorded in the optical disc D, the turntable 312 is housed in the optical disc apparatus 310. Where the housed table 312 is withdrawn, an eject button 313 mounted to a predetermined position of the optical disc apparatus 310 is depressed so as to cause a loading mechanism (not shown) to discharge the table 312 from the optical disc apparatus 310.

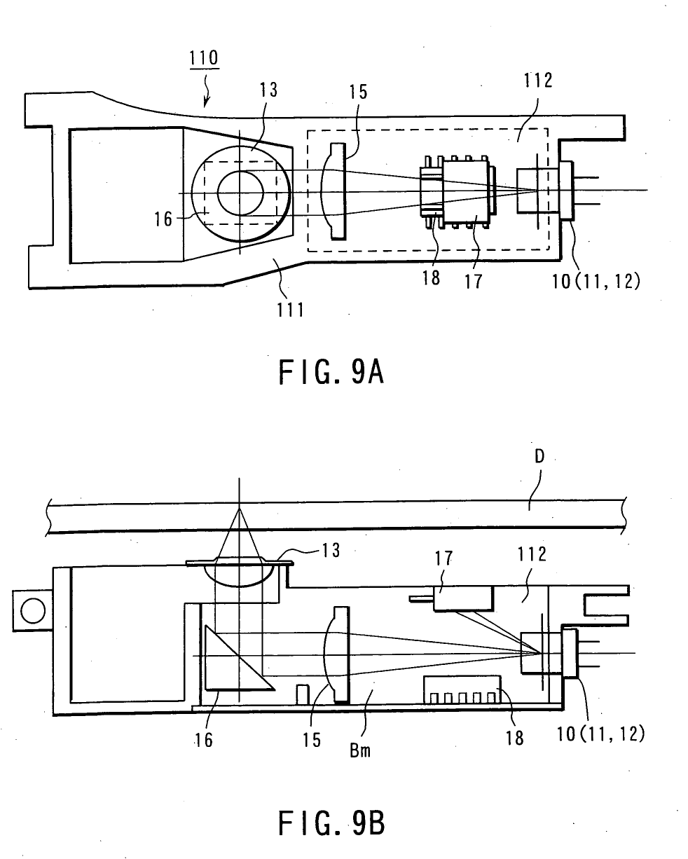

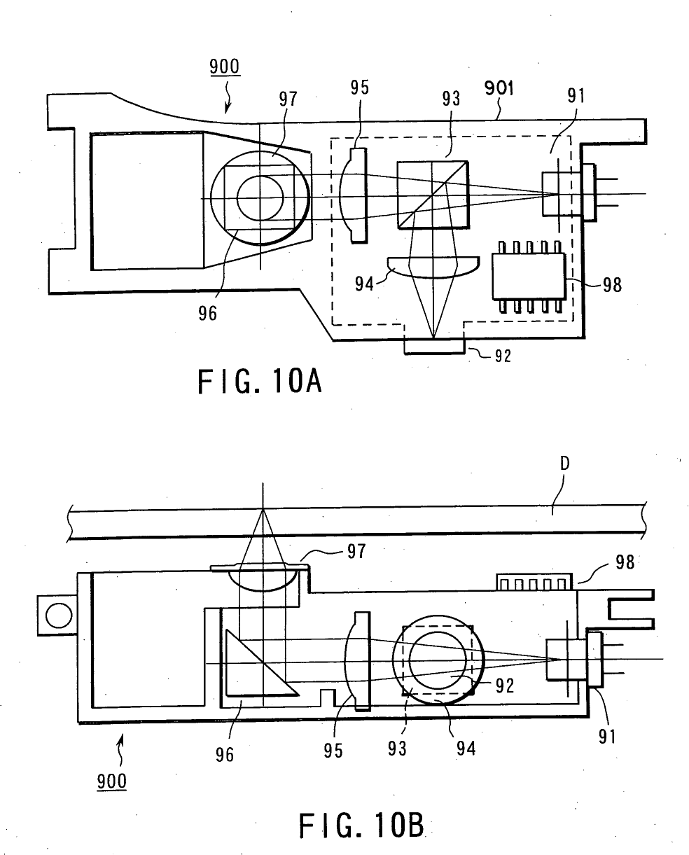

FIGS. 9A and 9B schematically show another embodiment of the optical head shown in FIGS. 2 to 6, wherein FIG. 9A is a plan view as viewed in a direction parallel to the recording surface of the optical disc, and FIG. 9B is a side view showing the state as viewed in a direction perpendicular to the recording surface of the optical disc.

As shown in FIGS. 9A and 9B, an optical head 110 includes a base 111. The IOU 10 for CD, which is arranged in a predetermined position of the base 111, includes a first light source of the laser diode 11 for emitting a laser beam (light beam) having the first wavelength and a light detector 12. The laser beam emitted from the laser diode 11 is reflected from the recording medium of the optical disc. The reflected laser beam is received by the light detector 12 so as to produce an electric signal conforming with the intensity of the reflected laser beam. The base 111 also has an open portion 112 housing an optical path for transmitting the laser beam of the first wavelength emitted from the laser diode 11 of the IOU 10 to the objective lens 13 for collecting the laser beam on the recording surface of the optical disc D.

The laser beam emitted from the laser diode 11 of the IOU 10 for CD, which has a wavelength of, for example, 780 nm and is gradually diverged along the optical path within the open portion 113, is guided by the collimator 15 and the mirror block 16, which are the optical members substantially equal in construction to those described previously in conjunction with FIGS. 1A and 1B, to the objective lens 13. Predetermined converging properties are imparted to the laser beam by the objective lens 13, and the laser beam is collected on a predetermined position on the recording surface of the optical disc D. The laser beam reflected from the recording surface of the optical disc D is brought back to the objective lens 13 so as to be collected on the light detector 12 within the IOU 10 through the mirror block 16 and the collimator 15.

A monitor light detector 17 for detecting the light amount of the laser beam emitted from the laser diode 11 of the IOU 10 for CD is arranged in a predetermined position, i.e., in the ceiling of the base 111 that can be fixed by a top cover that is not described in detail, of the open portion 112 formed within the base 111. On the other hand, a laser driving circuit member 18 for driving the laser diode 11 of the IOU 10 for CD is fixed to a predetermined position, i.e., the floor portion of the base 111 that can be fixed by a base cover that is not described in detail, within the open portion 112 of the base 111.

As described above, the laser driving circuit member 18 is arranged in the vicinity of the IOU 10 for CD and within the space formed between the inclined portion of the optical path on the emitting position of the diverging laser beam Bm and the floor portion of the base 111 on the side away from the optical disc D with the optical path interposed therebetween, as illustrated by the optical head shown in FIGS. 9A and 9B.

As described above, in the optical head shown in FIGS. 9A and 9B, the laser driving circuit 19 for driving the laser diode 11 within the IOU 10 is held in the space formed between the inclined portion of the base 111 and the floor portion of the base 110. It follows that the space having the optical path formed therein can be utilized more effectively compared with the optical head described previously, making it possible to further miniaturize the optical head.

As described above, in the optical head shown in FIGS. 9A and 9B, the space in which the optical path is formed is utilized efficiently so as to overcome the restriction of the layout*of the members housed in the optical head. It follows that it is possible to provide a miniaturized optical head having a small thickness.

FIG. 11 schematically shows in a dismantled fashion the main constituents of the optical head that can be utilized in any of the optical heads described with reference to FIGS. 1A and 1B, FIGS. 2 to 6, and FIGS. 9A and 9B.

An optical head 400 shown in FIG. 11 includes a first IOU 31 used for reproducing the data from a DVD disc and a second IOU 41 used for reproducing data from a CD disc.

The first IOU 31 has a first laser diode 32 (first light source) for emitting a laser beam having a first wavelength, a first light detector 33, and a first hologram element 34. The laser beam emitted from the first laser diode 32 passes through the first hologram element 34 and, then, through a wavelength selecting film 36 of a dichroic prism 35 with the diverging properties of the laser beam left unchanged. Further, the laser beam is collimated by a collimator 37. The laser beam collimated by the collimator 37 passes through a dichroic filter 38 and predetermined converging properties are imparted to the laser beam by an objective lens 39 so as to be collected on a predetermined position on the recording surface of the optical disc D.

The laser beam reflected from the recording surface of the optical disc D passes through the objective lens 39, the dichroic filter 38 and the collimator 37 so as to be brought back to the wavelength selecting film 36 of the dichroic prism 35. The reflected laser beam that has been brought back to the wavelength selecting film 36 passes again through the wavelength selecting film 36 so as to be diffracted by the first hologram element 34 of the first IOU 31 and, thus, to be collected on a predetermined position on the first light detector 33.

The second IOU 41 has a second laser diode 42 (second light source) emitting a laser beam having a second wavelength, a second light detector 43, and a second hologram element 44. The laser beam emitted from the second semiconductor laser 42 passes through the second hologram element 44, and predetermined converging properties are imparted to the laser beam by a coupling lens 45 for converting the large diverging angle of the diverging light flux of the laser beam having the second wavelength to a small diverging angle. Further, the laser beam is guided to the wavelength selecting film 36 of the dichroic prism 35. The laser beam having the second wavelength, which is guided to the wavelength selecting film 36 of the dichroic prism 35, is reflected by the wavelength selecting film 36 so as to be incident on the collimator 37. The diverging properties of the laser beam of the second wavelength incident on the collimator 37 are weakened by the collimator 37 so as to be guided to the dichroic filter 38. Then, the laser beam passes through a predetermined region of the dichroic filter 38 so as to be incident on the objective lens 39. Predetermined converging properties are imparted to the laser beam of the second wavelength incident on the objective lens 39 by the objective lens 39 so as to be collected on a predetermined position on the recording surface of the optical disc D.

The laser beam of the second wavelength, which is reflected from the recording surface of the optical disc D, passes through the objective lens 39, the dichroic filter 38 and, then, the collimator 37 so as to be brought back to the wavelength selecting film 36 of the dichroic prism 35. The reflected laser beam of the second wavelength, which has been brought back to the wavelength selecting film 36, is reflected by the wavelength selecting film 36 so as to be incident on the coupling lens 45. The reflected laser beam of the second wavelength incident on the coupling lens 45 is diffracted by the hologram element 44 of the second IOU 41 so as to be collected on the light receiving surface of the light detector 43.

The dichroic prism 40 will now be described. Specifically, the dichroic prism 40 is a cube having two corner cube prisms bonded to each other, which is an optical path synthesizing-separating element having a wave selection film 41 formed on the bonded plane of the two prisms. The wavelength selecting film 41 transmits substantially completely the laser beam (first light) having a wavelength of about 650 nm and emitted from the laser diode 32 of the first IOU 31 toward the DVD disc and reflects substantially completely the laser beam (second light) having a wavelength of about 780 nm and emitted from the laser diode 42 of the second IOU 41 toward the CD disc.

The dichroic filter 38 will now be described. Specifically, a circular opening-like wavelength selecting region is formed in the center of the dichroic filter 38. The laser beam having a wavelength of 650 nm, which is directed to a DVD disc, can be transmitted through the entire region of the dichroic filter 38. On the other hand, the laser beam having a wavelength of 780 nm, which is directed to a CD disc, can be transmitted only inside the circular opening-like wavelength selecting region that is formed in the center of the dichroic filter 38. It follows that the dichroic filter 38 provides a large opening with respect to the laser beam directed to the DVD disc, and provides a small opening with respect to the laser beam directed to the CD disc. In other words, the opening is narrowed with respect to the laser beam directed to the CD disc.

As described above, the dichroic filter 38 does not restrict the opening with respect to the laser beam having a wavelength of 650 nm and directed to the DVD disc and restricts the opening with respect to the laser beam having a wavelength of 780 m and directed to the CD disc such that the numerical aperture (NA) is not larger than 0.45.

The DVD disc system and the CD disc system are equal to each other in the operating principle of the reproduced signal system using signals generated from the light detectors 33, 43 of the first and second IOU 31, 41, respectively. To be more specific, the primary diffracted laser beam obtained by diffracting the laser beam reflected from the optical disc D by the corresponding hologram element 34 or 44 is received by the light detector 33 or 43 having a 4-divided or 6-divided photo diode so as to be converted into electric signals in the light detector 33 or 43. A reproduced signal, a focus error signal, a tracking error signal, etc. are obtained from the electric signals converted from the primary diffracted beam noted above.

In the optical head 400 shown in FIG. 11, the optical magnification is set at about 8, which can be regarded as an infinite system or a substantially infinite system, in the optical system for DVD in order to obtain the optimum reproducing characteristics in the DVD System. Therefore, the objective lens 39 and the collimator 37 are designed to satisfy this magnification. On the other hand, in the optical system for CD, the numerical aperture (NA) is set at 0.5 to meet the CD-R and CD-Rw standards, and the coupling lens 45 is arranged in addition to the objective lens 39 and the collimator 37 in order to increase the emitting power of the objective lens 39. By using the coupling lens 45, the optical magnification can be lowered while increasing the emitting power of the objective lens 39. In other words, it is possible to collect the laser beam for CD on the recording surface of the CD disc by utilizing the infinite system of the magnification 8 for DVD.

To be more specific, in the optical head 400 shown in FIG. 11, an ordinary convex lens is used as the coupling lens 45, and the spherical aberration is canceled by making optimum the lens curvature, thickness, position and the position of the light source so as to achieve a beam spot quality in which the wave front aberration is about 0.02 λrms.

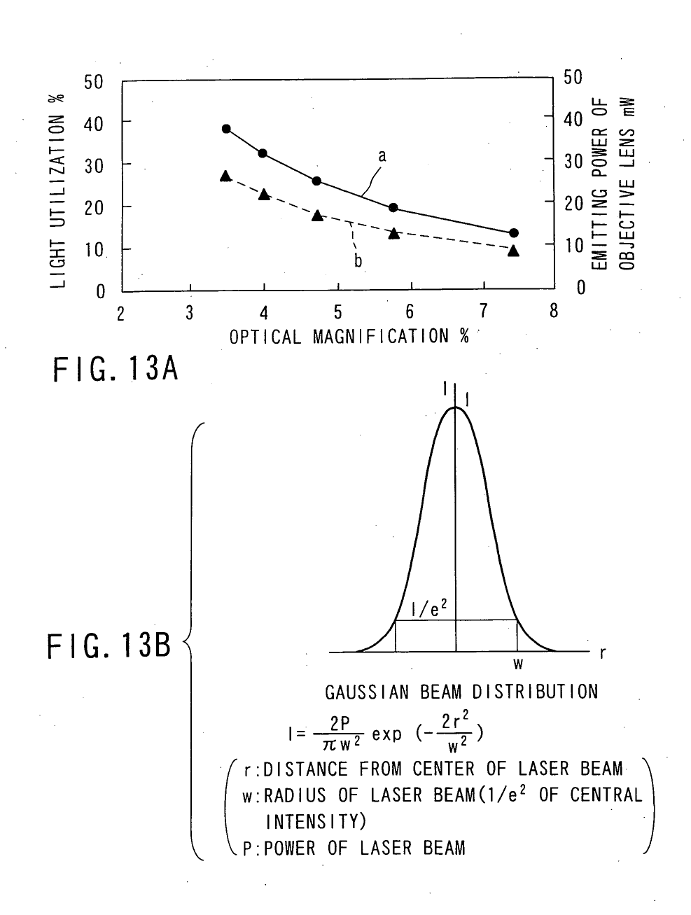

FIG. 13A is a graph showing the relationships between the optical magnification and the light utilization and between the optical magnification and the power of the laser beam emitted from the objective lens in the case of using the optical head shown in FIG. 11. It is clearly seen that both the light utilization, graphed by curve “a,” and the power of the laser beam emitted from the objective lens, which is graphed by curve “b,” decrease with an increase in the optical magnification. Also, as apparent from the Gaussian distribution shown in FIG. 13B, the light utilization is improved with a decrease in the optical magnification so as to increase the emitting power of the objective lens. If the optical magnification is made unduly small, however, the beam loading rate is lowered and other factors are increased. For example, the influence of the aberration in the optical path represented by the astigmatism is increased. As a result, the quality of the beam spot collected on the recording surface of the optical disc is lowered. When it comes to the transmittance of the laser beam, the number of optical members arranged in the optical path in the case of the DVD/CD common use is larger than that in the case of the optical system used exclusively for the CD, leading to reduction in the transmittance of light in the optical path. Under the circumstances, the optical magnification for the CD system is finally set at 4 in the optical head 400 shown in FIG. 11.

The relationship between the optical magnification and the light utilization shown in FIG. 13A is derived from the fact that the intensity distribution of the beam is as shown in FIG. 13B and has the relationship denoted by the formula shown in FIG. 13B. It follows that the intensity is high and the light is utilized efficiently in the portion where the beam radius is small.

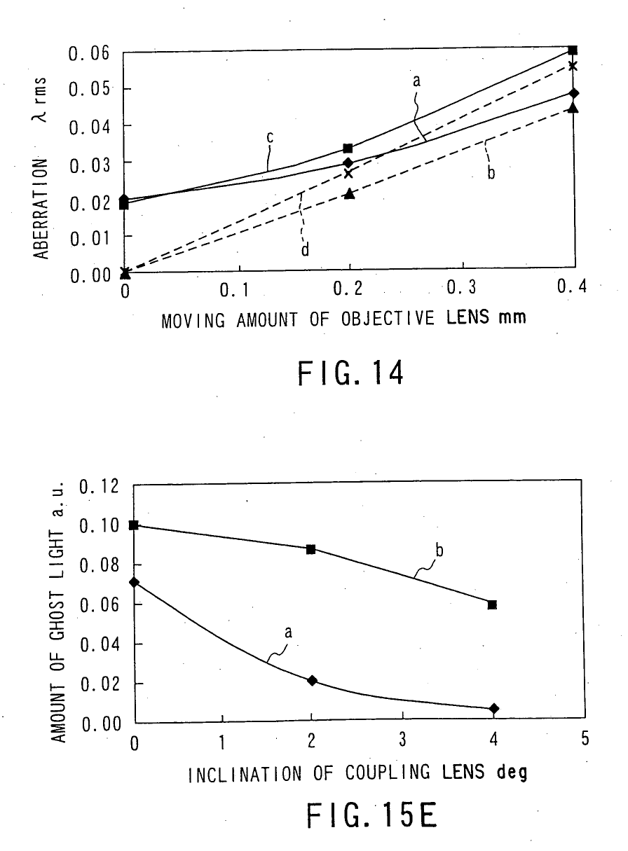

The ordinary convex lens (coupling lens) 45 is arranged such that the convex surface faces the objective lens on the side opposite to the light source. To be more specific, if the change in the beam spot wave front aberration λrms when a lens shift is imparted to the objective lens 39 is obtained on the basis that the total aberration in the case where the convex surface of the coupling lens 45 is positioned to face the objective lens 39 is represented by curve “a” shown in FIG. 14, the coma aberration in the case where the convex surface of the coupling lens 45 is positioned to face the objective lens 39 is represented by curve “b” shown in FIG. 14, the total aberration in the case where the convex surface of the coupling lens 45 is positioned to face the light source (laser diode) 31 is represented by curve “c” shown in FIG. 14, and the coma aberration in the case where the convex surface of the coupling lens 45 is positioned to face the light source (laser diode) 31 is represented by curve “d” shown in FIG. 14, the coma aberration can be suppressed even if a lens shift is imparted to the objective lens 39 in the case where the convex surface of the coupling lens 45 is positioned to face the objective lens 39.

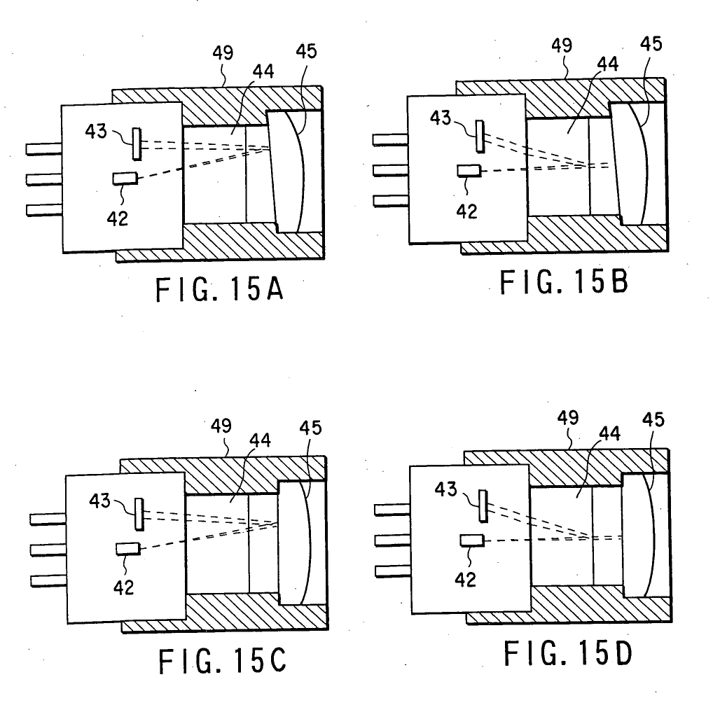

It should also be noted that the coupling lens 45 is arranged in a position at a predetermined angle inclined from the optical axis extending from the laser diode 42 toward the dichroic prism 35. This is done in order to suppress the ghost light that the laser beam emitted from the second laser diode 42 is reflected on the surface of the coupling lens (ordinary convex lens) 45 and the reflected light is partly incident on the light detector 37 as the ghost light. To be more specific, the laser beam reflected from the surface of the coupling lens 45, forms the ghost light in the case where the laser beam is not diffracted in the hologram element 44 so as to be incident on the light detector 33 as a zero (0) order diffracted light and in the case where the primary diffracted light is incident on the light detector 33. It should be noted that the ghost light in each of these cases can be suppressed by inclining the coupling lens 45 by a predetermined angle, e.g., 4°, from the optical axis shown in FIG. 15E. However, if the angle of inclination of the coupling lens 45 is excessively large, astigmatism is generated so as to lower the beam spot quality. Such being the situation, in the optical head 400 shown in FIG. 11, the coupling lens 45 is inclined from the optical axis by about 2°. Where the angle of inclination was set at 3°, the astigmatism was increased so as to aggravate the entire wave front aberration.

FIGS. 15A and 15B exemplify the routes of the ghost light caused by the 0-order light and the primary light in the case where the inclination was set at 4°. On the other hand, FIGS. 15C and 15D exemplify the routes of the ghost light caused by the 0-order light and the primary light in the case where the inclination was set at 0°. Incidentally, the hologram element 44 of the second IOU 41 used in the optical head 400 shown in FIG. 11 is made integral with the coupling lens 45 by an outer case 49.

As described above, in the optical head shown in FIG. 11, the optical magnification of the DVD system is set at about 8 and the optical magnification of the CD system is set at about 4 independently in spite of the construction that the single objective lens 39 is used for forming the optical systems for both the DVD disc and the CD disc. As a result, the data can be reproduced from both the DVD disc and the CD disc. Also, it is possible to obtain an optical head having characteristics adapted for recording of data in and reproduction of data from CD-R and CD-RW, free from deterioration of the characteristics, and capable of suppressing the ghost light in also the case where a lens shift is imparted to the objective lens 39.

FIG. 12 shows another embodiment of the optical head shown in FIG. 11. In the optical head shown in FIG. 12, an IOU is not used, and a laser diode and a light detector are used independently.

The optical head 500 shown in FIG. 12 includes a first laser diode 551 for emitting a laser beam for DVD having a wavelength of 650 nm, a second laser diode 561 emitting a laser beam for CD having a wavelength of 780 nm, a flat plate beam splitter 552 reflecting the laser beam emitted from the first laser diode 551 toward an objective lens 575, a wavelength selecting film 572, a prism beam splitter 571 that permits transmitting the laser beam reflected from the flat plate beam splitter 552 and reflects the laser beam emitted from the second laser diode, a collimator 573, and a dichroic filter 574. Also, a coupling lens 562 for setting the optical magnification of the CD system at a predetermined value is arranged between the second laser diode 561 and the prism beam splitter 571. On the other hand, the laser beam reflected from the optical disc D is incident on the flat plate beam splitter 552 through the objective lens 575 and a light detector 581 is arranged in a direction in which the reflected laser beam is transmitted through the flat plate beam splitter 552.

The wavelength selecting film 572 of the prism beam splitter 571 permits transmitting substantially 100% of the laser beam for DVD having a wavelength of 650 nm, and also permits transmitting about 50% of the laser beam for CD having a wavelength of 780 nm. Naturally, about 50% of the laser beam for CD having a wavelength of 780 nm is reflected from the wavelength selecting film 572. It should be noted that the flat plate beam splitter 552 is formed of a half mirror exhibiting a wavelength selecting capability. To be more specific, the flat plate beam splitter 552 permits transmitting 50% of the laser beam for DVD having a wavelength of 650 nm and reflecting the remaining 50% of the laser beam, and also permits transmitting 100% of the laser beam for CD having a wavelength of 780 nm. On the other hand, a circular opening-shaped wavelength selecting region is formed in the center of the dichroic filter 574. The laser beam for the DVD disc having a wavelength of 650 nm can be transmitted through the entire region of the dichroic filter 574. On the other hand, the laser beam for the CD disc having a wavelength of 780 nm is transmitted only inside the central circular opening-shaped wavelength selecting position of the dichroic filter 574. It follows that the dichroic filter 574 provides a large opening relative to the laser beam for the DVD disc, and the opening is restricted for the laser beam for the CD disc. In other words, the dichroic filter 574 performs the function of diminishing the opening in respect of the laser beam for the CD disc.

In the optical head 500 of the particular construction, the laser beam for DVD, which is emitted from the laser diode 551 and has a wavelength of 650 nm, is reflected from the flat plate beam splitter 552 in about half the light amount so as to be incident on the prism beam splitter 571. The laser beam having a wavelength of 650 nm, which is incident on the prism beam splitter 571, is transmitted through the wavelength selecting film 572 so as to pass through the collimator 573 and the dichroic filter 574 and, thus, to be incident on the objective lens 575.

The laser beam for the DVD disc having a wavelength of 650 nm, which is incident on the objective lens 575, is imparted with predetermined converging properties by the objective lens 575 so as to be collected on a predetermined position on the recording surface of the optical disc D.

The laser beam having a wavelength of 650 nm, which is reflected from the optical disc D, passes through the objective lens 575, the dichroic filter 574, the collimator 573 and the prism beam splitter 571 in the order mentioned so as to be brought back to the flat plate beam splitter 552. The laser beam reflected from the optical disc D, which is brought back to the flat plate beam splitter 552, then passes through the flat plate beam splitter 552 so as to be incident on the light detector 581.

On the other hand, the diverging angle of the laser beam for CD having a wavelength of 780 nm, which is emitted from the laser diode 561, is limited to a predetermined angle by the coupling lens 562 so as to be incident on the prism beam splitter 571 equipped with the wavelength selecting film 572. The laser beam for the CD disc having a wavelength of 780 nm, which is incident on the prism beam splitter 571, is reflected by the wavelength selecting film 572 and the reflected laser beam passes through the collimator 573 and the dichroic filter 574 so as to be incident on the objective lens 575.

The laser beam for the CD disc having a wavelength of 780 nm, which is incident on the objective lens 575, is imparted with predetermined converging properties by the objective lens 575 so as to be collected on a predetermined position on the recording surface of the optical disc D.

The laser beam having a wavelength of 780 nm, which is reflected from the optical disc D, passes through the objective lens 575, the dichroic filter 574 and the collimator 573 in the order mentioned so as to be brought back to the prism beam splitter 571. The laser beam having a wavelength of 780 nm, which has been brought back to the prism beam splitter 571, then passes through the prism beam splitter 571 and, further, through the flat plate beam splitter 552 so as to be incident on the light detector 581.

It should be noted that the optical head shown in FIG. 12 is equal to the optical head shown in FIG. 11 in respect of the optical magnification for each of the DVD disc and the CD disc as well as in the role and arrangement of the coupling lens 562.

It follows that it is possible to obtain an optimum beam spot in recording data in the CD-R disc or the CD-RW disc as well as in reproducing data from the DVD disc and the CD disc. Also, even in the case where a lens shift is imparted to the objective lens, it is possible to obtain an optical head low in deterioration of the characteristics and unlikely to be affected by the ghost light.

The optical head of the present invention is not limited to the embodiments shown in FIGS. 1A and 1B, FIGS. 2 to 6, FIGS. 9A and 9B, FIGS. 11 and 12. For example, a refractive index portion type lens having a layer differing in the refractive index in the thickness direction or the radial direction or a diffraction type lens utilizing the diffraction can be used as the coupling lens.

Also, in any of the embodiments described above, the coupling lens is arranged in a position inclined from the optical axis of the laser beam emitted from a laser diode for CD. Needless to say, however, the coupling lens can be applied to any optical head. Incidentally, the optical system including the laser diode, in which the coupling lens is arranged, constitutes the recording system to the optical disc of the CD type.

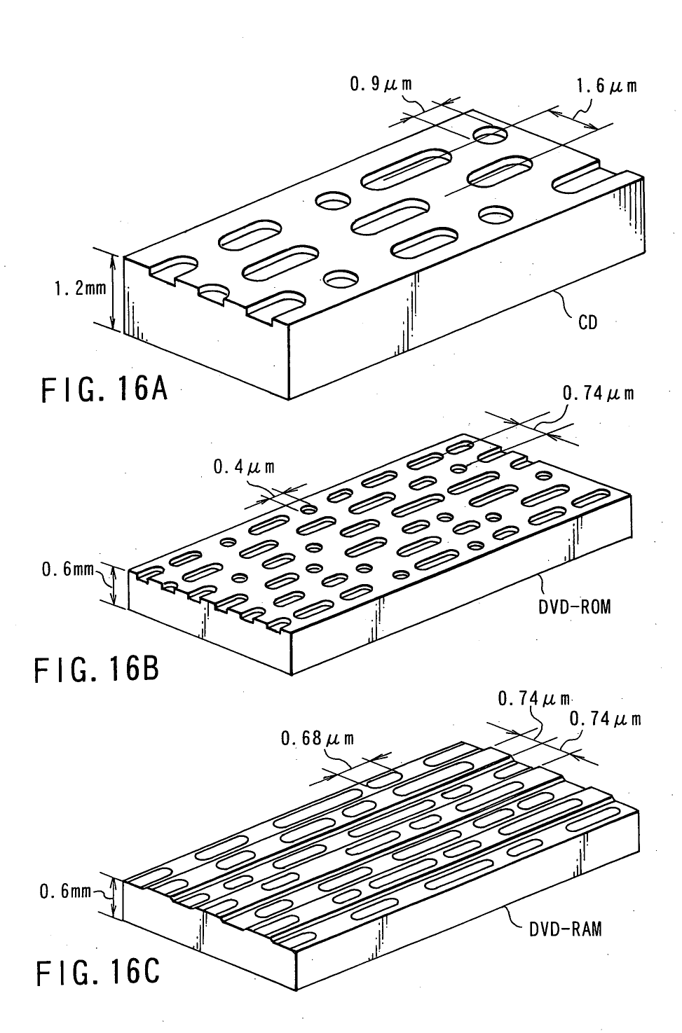

FIG. 16A shows the construction of the recording surface of a CD disc, and FIG. 16B shows the construction of the recording surface of a DVD-ROM. Further, FIG. 16C shows the construction of the recording surface of a DVD-RAM. As shown in these drawings, the individual optical discs D greatly differ from each other in the track pitch and in the shortest pitch length, making it necessary to use a light source capable of emitting laser beams differing from each other in the wavelength as described above.

FIG. 17 exemplifies the system of electric signals for processing the signals read by the optical head shown in each of FIGS. 1A and 1B, FIGS. 2 to 6, FIGS. 9A and 9B, FIGS. 11 and 12.

As shown in FIG. 17, photo diodes 6A, 6B, 6C, 6D, 6E and 6F are mounted in a light detector 606. The output of the photo diodes 6A, 6B, 6C, 6D, 6E and 6F are amplified by buffer amplifiers 623a, 623b, 623c, 623d, 623e and 623f, respectively, and output signals A to F are obtained from these buffer amplifiers.

The individual signals A to F are processed such that a signal (A+B) is formed by an adder 631, and a signal (C+D) is formed by another adder 632. The signal (A+B) formed by the adder 631 and the signal (C+D) formed by the adder 632 are processed by an adder 633 to form a signal {(A+B)−(C+D)}. The signal {(A+B)−(C+D)} is used as a focus error signal.

An adder 634 forms a signal (A+C), and an adder 635 forms a signal (B+D). These signals (A+C) and (B+D) are supplied to a phase difference detector 631. The output of the phase difference detector 631 is used as a tracking error signal of the DVD disc. On the other hand, a signal (E-F) obtained on the basis of the detection signal of the sub-beam is neglected by turning off a switch 642.

The signals (A+C) and (B+D) are also supplied to an adder 636. Incidentally, the adder 635 forms a signal (A+B+C+D), i.e., an HF signal. On the other hand, a signal (E-F) is formed from signals E and F by an adder 637. The signal (E-F) is used as a tracking error signal in the CD disc. In other words, a switch 652 is turned on when the optical disc apparatus including the optical head is in a CD reproduction mode. The circuit construction can be modified in various fashions and is not limited to that shown in FIG. 17.

The signal processing circuit described above covers the case where the laser beam reflected from each of the CD disc and the DVD disc is detected by a single light detector. Needless to say, however, it is possible to add a signal processing circuit by mounting an element to each of the light detectors included in the optical head shown in FIG. 11. Alternatively, it is possible for the signal processing circuit of the construction shown in FIG. 17 to be connected as it is to each of the light detectors. In this case, the switch is maintained at a constant state in accordance with the reproduced disc.

As described above, the present invention provides an optical head, which permits reproducing data from each of the DVD type disc and the CD type disc by using a single objective lens, which permits exhibiting appropriate characteristics in recording/reproducing data in and from CD-R or CD-RW, and which permits suppressing the deterioration of the characteristics and also permits suppressing the influence given by the ghost light even in the case where a lens shift is imparted to the objective lens.

The present invention also provides an optical head, which permits overcoming the restriction of the layout in mounting the parts and also permits mounting the optical disc in a thin optical disc apparatus.

Further, in the optical head of the present invention, many members, each has at least one of circuit members, are arranged on the side of the light source in which the diverging angle of the diverging laser beam is small so as to effectively utilize the space (open portion) within the optical head.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An optical head device comprising:
a light source for emitting a light beam having a predetermined wavelength;
a light source driving circuit for driving said light source for allowing said light source to emit said light beam;
a monitor light detector for detecting the light amount of said light beam emitted from said light source;
an objective lens for collecting the light beam on a predetermined position of said optical disc;
a light receiver for receiving said light beam reflected from said optical disc and for converting the received light beam into an electric signal;
a base having an open portion and holding an optical component arranged in the open portion for guiding said light beam in a manner to form an optical path of said light beam from said light source to said objective lens; and
a holder for holding said monitor light detector within the open portion of said base in parallel to the optical path and in a manner not to interfere with said light beam.

2. The optical head device according to claim 1, wherein
said holder includes a cover attached to said base for holding at least one of said light source, said light source driving circuit, said monitor light detector, said objective lens, and said light receiver.

3. The optical head device according to claim 2, wherein said base holds said cover with a predetermined clearance provided therebetween.

4. The optical head device according to claim 3, wherein said base permits a part of said light source driving circuit to be exposed to the outside through the clearance formed between said cover and said base.

5. An optical head used in an optical disc apparatus in which an optical disc is irradiated with a light beam for recording data in said optical disc or for reproducing data from said optical disc, at least one of a circuit component and element for reproducing or recording data being housed in said optical head, comprising:
a light source for emitting a light beam having a predetermined wavelength;
an objective lens for collecting said light beam for irradiating said optical disc with said light beam;
a driving mechanism for moving the objective lens in a predetermined direction for at least one of a focusing and a tracking to the optical disc;
a light receiver for receiving said light beam reflected from said optical disc and for converting said received light beam into an electric signal;
a base having an open portion and holding an optical component arranged in the open portion for guiding said light beam in a manner to form an optical path of said light beam from said light source to said objective lens;
a light source driving circuit for driving the light source;
a signal processing circuit for processing the electric signal from said light receiving element;
a driving mechanism driving circuit for driving the driving mechanism; and
a holder for holding at least one of said driving circuit, said light source driving circuit, said signal processing circuit, and said driving mechanism driving circuit within the open portion of said base in parallel manner to said optical path within said base and in a manner not to interfere with said optical path within said base.

6. The optical head according to claim 5, wherein the beam emitted from the light source exhibits diverging properties that the beam is gradually diverged with increase in the distance from the light source.

7. The optical head according to claim 5, wherein said driving mechanism driving circuit has a yoke constituting a magnetic circuit, and the holder does not project beyond the height to which the yoke projects within the open portion of said base.

8. An optical head used in an optical disc apparatus in which an optical disc is irradiated with a light beam so as to record data in the optical disc, comprising:
a light source emitting a light beam having a predetermined wavelength;
a light source driving part for driving the light source;
a monitor light detecting part for detecting the light amount of the light beam emitted from the light source;
an objective lens for collecting the light beam on a predetermined position of the optical disc;
a base having an open portion and holding an optical part within the open portion, the optical part guiding the light beam in a manner to form an optical path of the light beam from the light source to the objective lens; and
holding means for holding the monitor light detecting part within the open portion of the base in parallel to the optical path and in a manner not to interfere with the light beam.

9. The optical head according to claim 8, wherein the light source driving part is held within the open portion together with the monitor light detecting part along the optical path.

10. An optical head used in an optical disc apparatus in which an optical disc is irradiated with a light beam for reproducing data from the optical disc or for recording data in the optical disc, comprising:
an objective lens;
a light source emitting a light beam having a predetermined wavelength;
a light source driving part for driving the light source;
a base having an open portion and holding an objective lens and the light source within the open portion in a manner to define an optical path of a predetermined length; and
a cover for holding the light source driving part in a position parallel to the optical path within the open portion so as not to interfere with the beam.

11. The optical head according to claim 10, wherein said base holds said cover with a predetermined clearance provided therebetween.

12. The optical head according to claim 11, wherein said base permits a part of said light source driving part to be exposed to the outside through the clearance formed between the cover and said base.

13. The optical head according to claim 11, wherein said light source driving part is fixed to the cover with a flexible printed circuit interposed therebetween.

14. An optical head used in an optical disc apparatus in which an optical disc is irradiated with a light beam so as to record data in the optical disc, comprising:
an objective lens;
a light source for emitting a beam having a predetermined wavelength;
a monitor light detector member for detecting the light amount of the beam emitted from the light source;
a base having an open portion and holding the lens and the light source within the open portion so as to maintain a predetermined length of the optical path between the lens and the light source; and
a flexible printed circuit member for mounting the monitor light detector within the open portion along the optical path of the beam so as not to interfere with the beam.

15. An optical disc apparatus in which an optical disc is irradiated with a light beam by using an optical head so as to record data in the optical disc or to reproduce data from the optical disc, comprising:
a guide member for guiding the optical head when the optical head is moved in a radial direction of the disc;
a signal processing circuit member for controlling the data recording or data reproduction by using the optical head;
a light source for emitting a light beam having a predetermined wavelength;
an objective lens for collecting the light beam on the optical disc;
an actuator for changing the position of the objective lens for the tracking adjustment or for the focus adjustment of the light beam irradiating the optical disc;
a yoke included in the actuator for imparting a driving force for changing the position of the objective lens in cooperation with a coil;
a light receiving element receiving the light beam reflected from the optical disc and converting the received light beam into an electric signal;
a base having an open portion and holding an optical member for guiding the light beam within the open portion so as to form an optical path ranging between the light source and the objective lens; and
holding means for holding at least one member selected from the group of the signal processing circuit member, the actuator, and a circuit for processing the electric signal generated from the light receiving element within the open portion so as not to interfere with the optical path of the beam and in parallel to the optical path.
